(19) United States
(12) Patent Application Publication
(10) Pub. No.: US 2009/0219168 A1
(43) Pub. Date: Sep. 3, 2009

(54) LIVING POSTERS

(75) Inventor: Bill Loper, Pacific Palisades, CA (US)

Correspondence Address: PROCOPIO, CORY, HARGREAVES & SAVITCH LLP, 530 B STREET, SUITE 2100, SAN DIEGO, CA, 92101, US

(73) Assignees: SONY CORPORATION, Tokyo (JP); SONY PICTURES ENTERTAINMENT INC., Culver City, CA (US)

(21) Appl. No.: 12/396,326

(22) Filed: Mar. 2, 2009

Related U.S. Application Data
(60) Provisional application No. 61/032,841, filed on Feb. 29, 2008.

(51) Int. Cl. G06F 13/42; G06T 13/00

(52) U.S. Cl. 340/825; 345/473

(57) ABSTRACT

Presenting a sequence of images including: displaying a static image, wherein the static image includes at least one object in a static state; defining a triggering event that changes the static state of the at least one object; defining the changes to the static state of the at least one object in a dynamic sequence of images; and moving the at least one object in the static image according to the dynamic sequence of images when the triggering event is detected.

### CROSS-REFERENCE TO RELATED APPLICATIONS

This application claims the benefit of priority of co-pending U.S. Provisional Patent Application No. 61/032,841, filed Feb. 29, 2008, entitled “Living Posters.” The disclosure of the above-referenced provisional application is incorporated herein by reference.

### BACKGROUND

1. Field of the Invention

The present invention relates to advertisements, and more specifically, to presenting a sequence of images for such advertisements.

2. Background

In a conventional advertisement for movies or online games, the image is either static or moving. A static advertisement includes static posters or billboards. A moving advertisement includes television advertisements providing a video sequence. Further, mechanical rollers can be used to mechanically advance a few sheets of rolled-up posters having a different advertisement in each sheet. Viewers of advertising and images have become accustomed to this paradigm and expect an advertisement that is in the format of a typically static image and that is not moving.

### SUMMARY

In one implementation, a method for presenting a sequence of images is disclosed. The method including: displaying a static image (e.g., advertising a movie or online game), wherein the static image includes at least one object in a static state; defining a triggering event that changes the static state of the at least one object; defining the changes to the static state of the at least one object in a dynamic sequence of images; and moving the at least one object in the static image according to the dynamic sequence of images when the triggering event is detected.

In another implementation, a system to present a sequence of images is disclosed. The system including: a media presentation including a static image, a dynamic sequence of images, and control information that defines timing, duration, and triggering event for displaying the static image and the dynamic sequence of images; and a display system including storage, an ambient detector, and a processor, the processor configured to receive and store the media presentation in the storage, and to display the static image and the dynamic sequence of images based on the control information and information from the ambient detector.

Other features and advantages of the present invention will become more readily apparent to those of ordinary skill in the art after reviewing the following detailed description and accompanying drawings.

### BRIEF DESCRIPTION OF THE DRAWINGS

FIG. 1 is a flowchart illustrating a process for presenting a sequence of images in a dynamic content format including video and/or audio in accordance with one implementation of the present invention.

FIG. 2 is a block diagram of a system configured to present a sequence of images in a dynamic content format including video and/or audio in accordance with one implementation of the present invention.

### DETAILED DESCRIPTION

In view of the conventional advertisement paradigm discussed above, there is a need for a paradigm shift that can increase and draw the interest and enjoyment of viewers, such as movie viewers or online game players.

Certain implementations as disclosed herein provide for presenting a sequence of images in a dynamic content format including video and/or audio. After reading this description it will become apparent how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention.

In one implementation, a wall-mounted display device displays a poster format image advertising a movie or online game and the image is initially static, such as in the advertisement for a movie in a theater or shopping mall. (Other implementations could be advertising other products or services.) After a defined period of time or other trigger, the displayed image begins to move. For example, the display shows an initial image of an actor in a static pose, similar to a typical one-sheet movie poster. After ten seconds, the image changes to show the actor winking, coughing, or smiling and then returns to show the same static pose. Various other actions or images can occur in different applications and implementations.

Features provided in implementations can include, but are not limited to, one or more of the following items: an electronic display of an advertising image that changes after a trigger, such as time; defining triggers based on changes in the environment of the display; defining changes to occur based on changes in the environment of the display; and audio that changes to match changing images.

In another implementation, dynamic media is initially displayed to a viewer in a static format. The viewer views what appears to be a static image, but after some triggering event, the image changes. For example, the event is a certain amount of time elapsing, a trigger from a motion detector which detects the presence of a viewer, or a trigger from a noise detector which detects the conversation of viewers nearby. In the advertising or entertainment context, this event which detects changes in situation can surprise the viewer, thereby increasing interest and/or enjoyment.

In a further implementation, a content provider prepares a media presentation. The media presentation includes metadata to display images in three sections over time: an initial static section, a dynamic section, and a final static section. The initial static section is a static image. The dynamic section includes a sequence of images or video. The final static section is another static image. Alternatively, the initial static section and the final static section use the same image. In another alternative implementation, the entire presentation is one video sequence except for some period (e.g., initially and finally) where the image: (1) appears not to change, or (2) is a sequence of repeated frames. More complicated sequences can also be created. For example, in one variation, a sequence of frames is initially presented in a loop. When a predefined frame is reached a pre-selected video sequence is inserted. Then, when the video sequence is finished, the sequence of frames is restarted from a next frame after the predefined frame. The content provider may also include in the presentation, control information or instructions to control how the image data will be used.

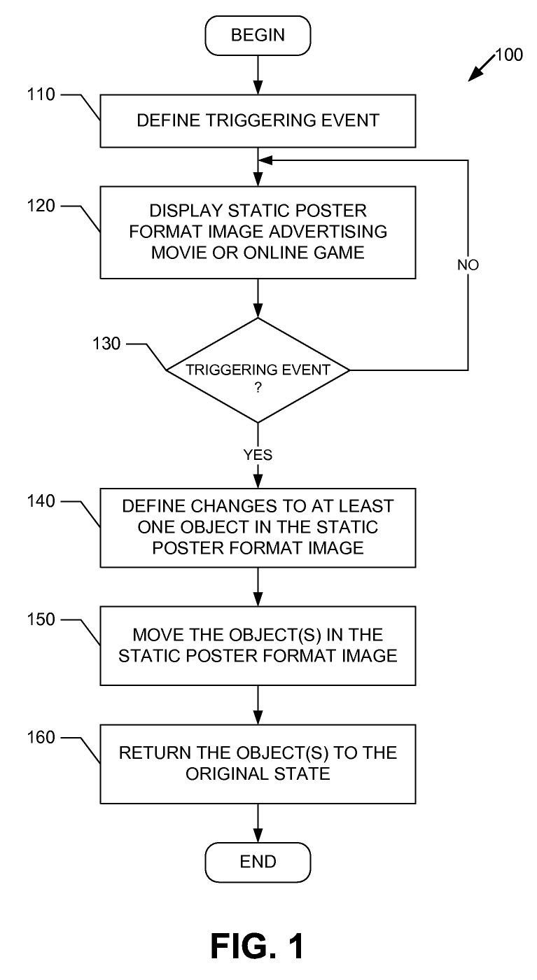

FIG. 1 is a flowchart 100 illustrating a process for presenting a sequence of images in a dynamic content format including video and/or audio in accordance with one implementation of the present invention. A triggering event is initially defined, at box 110, to define when and/or how to change object(s) in a static poster format image (e.g., similar to a typical one-sheet movie poster) which advertises a movie or online game. In one configuration, object(s) includes actor(s).

As discussed above, a triggering event includes a predetermined amount of time, a trigger from a motion detector which detects the presence of viewer(s) nearby, or a trigger from a noise detector which detects the conversation of viewer(s). The triggering event may detect changes in the environment of a display displaying the static poster format image. In one variation, the triggering event includes analysis of sound or motion detected by the detector. That is, the triggering event is not just triggered by the sound or motion but rather by the analysis of the sound or motion. For example, a triggering event is detected by sound of a sneeze, wherein an audio response such as “Bless you!” is provided.

Then, at box 120, the poster format image is statically displayed until the occurrence of the triggering event. In one configuration, the poster format image is displayed on a wall-mounted display device located in a theater or shopping mall. When it is detected, at box 130, that the triggering event has occurred, changes to at least one object in the static poster format image is defined, at box 140, and the object(s) to be changed is adjusted or moved, at box 150. The image changes are made to object(s) to increase and draw the interest and enjoyment of the movie viewers or online game players. For example, changes to the image include movement of object(s) such as the winking, coughing, or smiling by an actor. Changes to various other actions or images can occur in different applications and implementations. For example, in response to the triggering event, audio is played or changed to match the changing images. Optionally, the object(s) is returned to the state(s) that is substantially similar to the initial static state, at box 160.

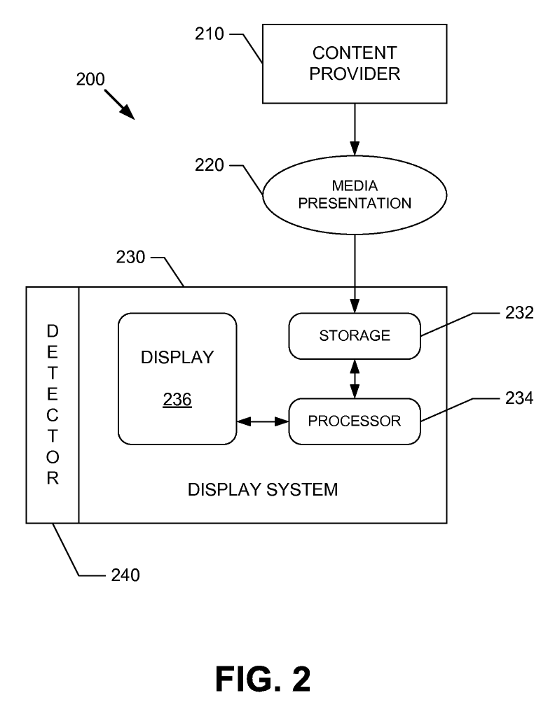

FIG. 2 is a block diagram of a system 200 configured to present a sequence of images in a dynamic content format including video and/or audio in accordance with one implementation of the present invention. In the illustrated implementation of FIG. 2, a content provider 210 prepares a media presentation 220. In one implementation, the media presentation 220 includes metadata to display images in three sections over time. The sections include an initial static section, a dynamic section, and a final static section. The initial static section is a static image. The dynamic section includes a sequence of images or video. The final static section is another static image. Alternatively, the initial static section and the final static section use substantially similar images. In another alternative implementation, the entire presentation 210 is one video sequence except for some period the image (initially and finally) appears not to change or is a sequence of repeated frames. The content provider 210 may also include in the presentation 220, control information or instructions to control how the image data will be used. The content provider 210 stores the presentation 220 in a display system 230 that can present the media presentation 220. The display system 230 includes a display 236 (e.g., LCD panel), storage 232 (e.g., memory, an optical drive, or a hard disk drive), a processor 234 to control display, a detector 240 to detect ambient movements and noises, and other typical components of an electronic display system (e.g., power, etc.). The processor 234 uses stored control information and instructions to access and display the stored media presentation images according to the design of the content provider.

In one implementation of the media presentation 220, the content provider 210 creates an image of a person sitting in a chair in an initial position, such as by photographing or otherwise capturing the image of an actor sitting in a chair. In other implementations, any scene can be captured, with multiple actors and/or objects. The content provider 210 then creates a dynamic image (or video sequence) of the person in the chair moving from the initial position, stretching, yawning, and returning to a position near the initial position. The content provider 210 then creates an image of the person sitting in the chair in a final position. Alternatively, the content provider 210 can generate transition data to create artificial images (as oppose to captured images) to show a transition from the final position of the dynamic image to the initial position. In one configuration, the initial and final positions of the actor are substantially similar but not identical. In another configuration, the images can all be captured as a single sequence and certain segments or frames are selected for displaying. Some frames can be optionally modified during editing.

In another implementation, the content provider 210 selects control information to indicate the duration and timing of the static image display and the dynamic image display. For example, the content provider 210 may determine that the entire sequence should last 30 seconds. The dynamic image sequence of the person stretching and yawning lasts 7 seconds. So, the control information indicates to display the first static image for 15 seconds, display the dynamic section for 7 seconds, and then display the final static image for the remaining 8 seconds. The control information may also include loop information to repeat the sequence or information indicating a new sequence to display.

In a further implementation, the media presentation 220 includes multiple dynamic sequences and or static images. The static images and dynamic sequences can be combined in various ways. For example, when the media presentation 220 is one presentation among many being rotated through a display system 230, it may be desirable to change which dynamic sequence is being used. For example, the media presentation 220 can specify a following sequence: static image 1, one of dynamic sequences 1, 2, or 3, then static image 2. In this configuration, different timing information can also be included to keep the total presentation length consistent. In another configuration where more time is available to the media presentation 220, a more complicated sequence can be used. For example, the media presentation 220 can specify a following sequence: static image 1, dynamic sequence 1, static image 2, dynamic sequence 2, static image 3, and so on.

In yet another implementation, the trigger or control for changing from the static image to the dynamic image is based on the environment of the display system 230. For example, the control information can be based on time of day such as morning or evening. For example, during the morning wait 1 minute, or during the evening wait 15 seconds. The control information can also be based on other factors such as date, temperature (e.g., trigger as temperature drops/rises), ambient noise, music, specific noises or words, light level, location, movement, and specific images, some of which may be detected by the detector 240. The control information can also be used to control which dynamic sequence is selected.

Combining the environment information with selectable dynamic sequences provides a dynamic and interactive system 200. For example, the detector 240 in the display system 230 can be configured to recognize the audio sound of a sneeze or cough and then select a dynamic sequence that responds to that sound, which may include an audio response such as “Bless you!” The display system 230 can be configured to recognize the sound of a phone ringing and display a sequence reacting to that sound such as the actor searching for the actor's phone in pockets, or a disapproving/annoyed expression. In another example, the detector 240 in the display system 230 can recognize music at a certain volume and select a dynamic sequence to show the actor(s) dancing or enjoying the music.

In other implementations, the configuration of the display system 230 can be varied using different configurations for the detector 240. For example, using motion sensing, the display system 230 can elect not to display the dynamic sequences when there are no viewers detected. In another example, using image recognition, the selected dynamic sequence can react to specific images such as waving excitedly when an image is detected (such as on a T-shirt of a passerby) from the movie being advertised by the media presentation 220. In yet another example, using GPS location information, the system 200 can select dynamic sequences (and corresponding audio) that are location-appropriate (e.g., local language), which allows a single media presentation to be distributed to multiple locations or to be distributed without pre-selecting the destination.

Additional variations and implementations are also possible. For example, depending on the type of display technology used, power consumption can be reduced while displaying the static images (e.g., by providing less power to the display elements while a static image is maintained and providing more power when displaying a changing image). In addition, the examples described above focus on changing video images, but other aspects of the media presentation can also be changed, such as audio. Further, this technology can be applied in many different situations, such as poster or billboard advertising situations, electronic or online advertising, amusement applications (e.g., at an amusement park), picture frame displays, or in applications where the viewer is not necessarily aware that they are seeing a displayed image as opposed to a physical image (e.g., background walls in a restaurant).

Various implementations of the invention are realized in electronic hardware, computer software, or combinations of these technologies. Some implementations include one or more computer programs executed by one or more computing devices. In general, the computing device includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., game controllers, mice and keyboards), and one or more output devices (e.g., display devices).

The computer programs include executable code that is usually stored in a persistent storage medium and then copied into memory at run-time. At least one processor executes the code by retrieving program instructions from memory in a prescribed order. When executing the program code, the computer receives data from the input and/or storage devices, performs operations on the data, and then delivers the resulting data to the output and/or storage devices.

Those of skill in the art will appreciate that the various illustrative modules and method steps described herein can be implemented as electronic hardware, software, firmware or combinations of the foregoing. To clearly illustrate this interchangeability of hardware and software, various illustrative modules and method steps have been described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Additionally, the steps of a method or technique described in connection with the implementations disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An example storage medium can be coupled to the processor such that the processor can read information from, and write information to, the storage medium. In the alternative, the storage medium can be integral to the processor. The processor and the storage medium can also reside in an ASIC.

1. A method for presenting a sequence of images, the method comprising:
displaying a static image,
wherein the static image includes at least one object in a static state;
defining a triggering event that changes the static state of the at least one object;
defining the changes to the static state of the at least one object in a dynamic sequence of images; and
moving the at least one object in the static image according to the dynamic sequence of images when the triggering event is detected.

2. The method of claim 1, further comprising returning the at least one object to a state substantially similar to the static state.

3. The method of claim 1, wherein the triggering event includes elapsing of a predetermined amount of time.

4. The method of claim 1, wherein the triggering event includes detection of presence of persons nearby.

5. The method of claim 1, wherein the triggering event includes detection of conversation of person nearby.

6. The method of claim 1, wherein the dynamic sequence of images includes body movements of a person including winking, coughing, or smiling.

7. The method of claim 1, further comprising playing audio that matches the dynamic sequence of images when the triggering event is detected.

8. The method of claim 1, further comprising
generating a media presentation including the static image and the dynamic sequence of images; and
generating control information for the media presentation to indicate duration and timing of the static image and the dynamic sequence of images.

9. The method of claim 8, wherein the control information is generated based on time of day.

10. The method of claim 8, wherein the control information is generated based on at least one of environmental factors including date, temperature, ambient noise, music, specific noises or words, light level, location, movement, and specific images.

11. The method of claim 10, wherein the control information also includes a selection parameter for selecting the dynamic sequence of images from a series of sequences so that the selected dynamic sequence matches the environmental factors associated with the control information.

12. A system to present a sequence of images, comprising:
a media presentation including a static image, a dynamic sequence of images, and control information that defines timing, duration, and triggering event for displaying the static image and the dynamic sequence of images; and
a display system including storage, an ambient detector, and a processor, said processor configured to receive and store the media presentation in the storage, and to display the static image and the dynamic sequence of images based on the control information and information from the ambient detector.

13. The system of claim 12, wherein the static image and the dynamic sequence of images together form one video sequence,
wherein a predetermined number of initial and final frames of the video sequence is visually unchanging.

14. The system of claim 12, wherein said media presentation further comprises
a sequence of responses configured to be played when the ambient detector detects a predefined event.

15. The system of claim 14, wherein the predefined event includes audio detected by the ambient detector.

16. The system of claim 14, wherein the predefined event includes motion detected by the ambient detector.

17. The system of claim 14, wherein the predefined event includes a location of the display system detected by the ambient detector.

18. The system of claim 17, wherein the sequence of responses includes using a local language according to the detected location.

19. The system of claim 14, wherein the predefined event is detection of no viewers, and the sequence of responses includes not displaying the dynamic sequence of images.

20. The system of claim 12, wherein the processor causes less power to be consumed while displaying the static image than while displaying the dynamic sequence of images.
